(19) United States
(12) Patent Application Publication
(10) Pub. No.: US 2017/0262928 A1
(43) Pub. Date: Sep. 14, 2017

(54) Virtual Shopping System, Apparatus and Method

(71) Applicant: Mario Antonio CLARKE, Lauderdale Lake, FL (US)

(72) Inventor: Mario Antonio CLARKE, Lauderdale Lake, FL (US)

(21) Appl. No.: 15/453,896

(22) Filed: Mar. 8, 2017

Related U.S. Application Data
(60) Provisional application No. 62/306,604, filed on Mar. 10, 2016.

(51) Int. Cl. G06Q 30/06

(52) U.S. Cl. CPC G06Q 30/0633; G06Q 30/0643

(57) ABSTRACT

A shopping method, apparatus and system. The method includes retrieving information of at least one shopper, creating a shopping environment based on the information, directing the at least one shopper through the shopping environment, where the shopping environment mimics a real-world shopping experience, and finalizing the shopping experience, where the finalizing is at least one of checking out and terminating the shopping.

### CROSS REFERENCE TO RELATED APPLICATION

This application relates to U.S. Provisional Applications 62/306,604 filed on Mar. 10, 2016, which is incorporated herein by reference in their entirety to provide continuity of disclosure.

### FIELD OF THE INVENTION

The disclosure relates to a virtual shopping systems, apparatus and methods. More specifically, this disclosure relates to creating and operating a virtual shopping platform that mimics an actual shopping experience

### BACKGROUND OF THE INVENTION

It has become more common for shoppers to surf the internet in and purchase more items over online shopping venues. However, the current online experience is very limited and does not compare to the real-world shopping experience. Therefore, there is a need for an improved system, apparatus and method for online and/or virtual shopping.

### SUMMARY OF THE INVENTION

Embodiments described herein relate to a virtual shopping method, apparatus and system. The method includes retrieving information of at least one shopper, creating a shopping environment based on the information, directing the at least one shopper through the shopping environment, where the shopping environment mimics a real-world shopping experience, and finalizing the shopping experience, where the finalizing is at least one of checking out and terminating the shopping.

### BRIEF DESCRIPTION OF DRAWINGS

Reference will now be made to the following drawings:

FIG. 1A and FIG. 1B are embodiments illustrating a flow diagram depicting virtual shopping methods;

FIG. 2 is an embodiment illustrating an embodiment of a virtual shopping system;

FIG. 3 is a block diagram illustrating an embodiment of a virtual shopping apparatus;

### DETAILED DESCRIPTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

It will be appreciated by those skilled in the art that aspects of the present disclosure may be illustrated and described herein in any of a number of patentable classes or context including any new and useful process, machine, manufacture, or composition of matter, or any new and useful improvement thereof. Therefore, aspects of the present disclosure may be implemented entirely in hardware or combining software and hardware implementation that may all generally be referred to herein as a “circuit,” “module,” “component,” or “system” (including firmware, resident software, micro-code, etc.). Further, aspects of the present disclosure may take the form of a computer program product embodied in one or more computer readable media having computer readable program code embodied thereon.

Any combination of one or more computer readable media may be utilized. The computer readable media may be a computer readable signal medium, any type of memory or a computer readable storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium would include, but are not limited to: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain, or store a program for use by or in connection with an instruction execution system, apparatus, or device.

Computer program code for carrying out operations utilizing a processor for aspects of the present disclosure may be written in any combination of one or more programming languages, markup languages, style sheets and JavaScript libraries, including but not limited to Windows Presentation Foundation (WPF), HTML/CSS, XAML, and JQuery, C, Basic, *Ada, Python, C++, C#, Pascal, *Arduino. Additionally, operations can be carried out using any variety of compiler available.

Aspects of the present disclosure are described herein with reference to flowchart illustrations and/or block diagrams of methods, systems and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, processor, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, processor, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

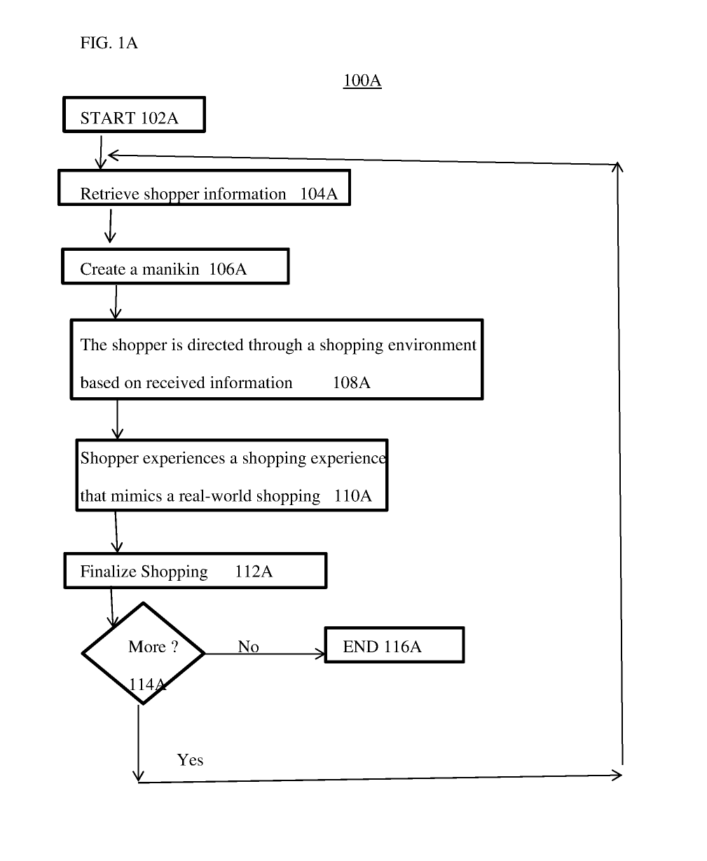

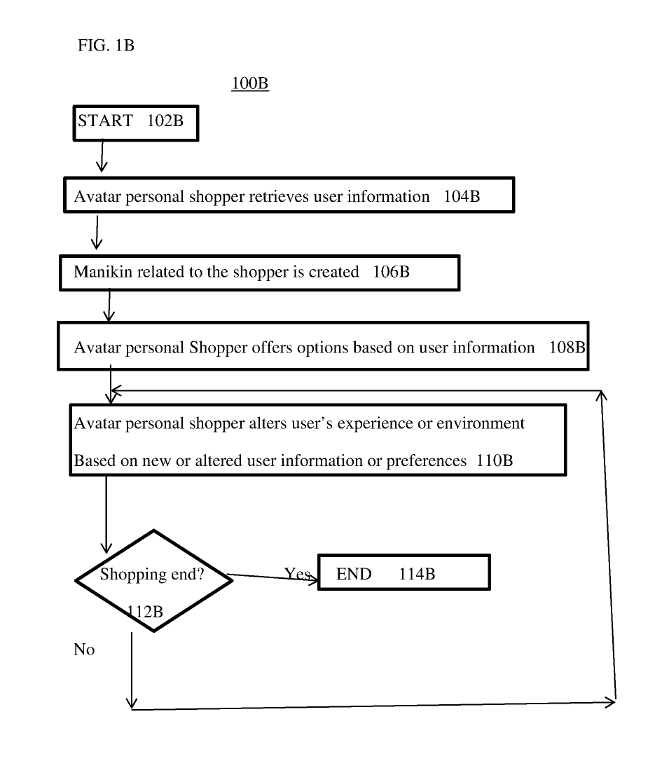

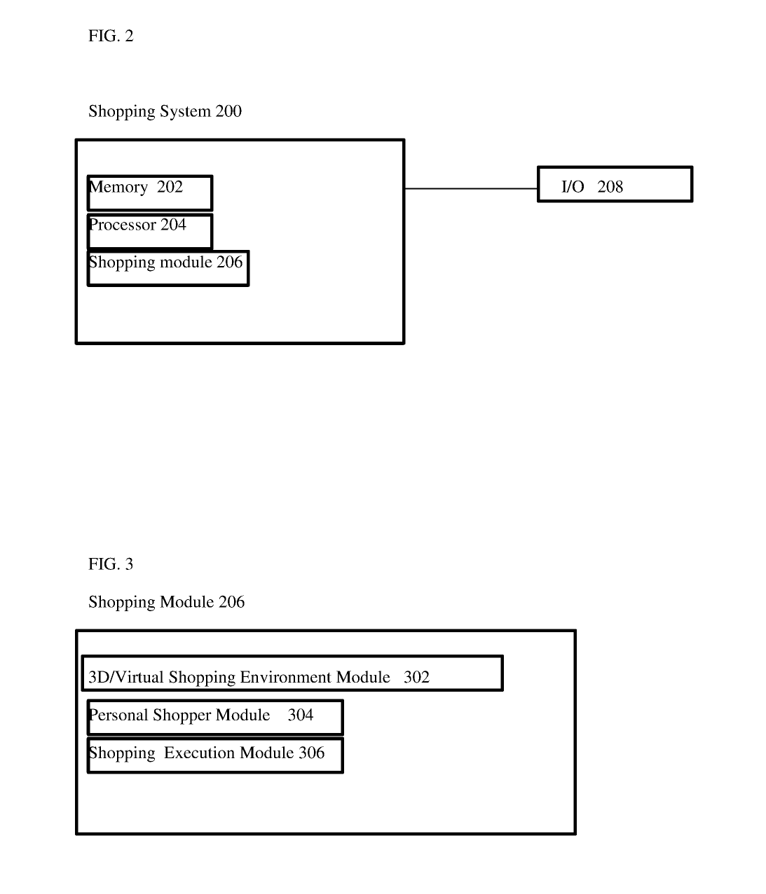

FIG. 1A and FIG. 1B are embodiments illustrating a flow diagram depicting virtual shopping methods. FIG. 1A and FIG. 1B depict flow diagram illustrating embodiments of virtual shopping methods 100A and 100B, respectively, that may be performed by system and apparatus of FIG. 2 and FIG. 3.

Method 100A starts at step 102A and proceeds to step 104A. At step 104A, the method 100A retrieves shopper information. At step 106A, method 100A creates a manikin based on the shopper information. At step 108A, the shopper is directed through a virtual shopping environment based on the shopper information. At step 110A, the shopper experiences a virtual shopping experience that mimics a real-world shopping experience. The shopper may be able to explore different stores in a mall, try on different outfits on the manikin, etc. At step 112A, the shopper finalizes the shopping. At step 114A, the method 100A determines if the shopper desirers to do more shopping. If so, the method 100A proceeds to step 104A; otherwise, the shopping ends at step 116A.

Method 100B starts at step 102B and proceeds to step 104B. At step 104B, an avatar personal shopper retrieves shopper information. In one embodiment, the avatar personal shopper resembles a virtual person that communicates (i.e. talk and/or converses) with the shopper. At step 106B, method 100B creates a manikin based on the shopper information. At step 108B, the avatar personal shopper offers options based on the shopper information. At step 110B, the avatar personal shopper alters the shopper's experience on environment based on new or altered shopper's information or preferences. The shopper may be able to explore different stores in a mall, try on different outfits on the manikin, etc. At step 112B, the method 100B determines if the shopper has finished shopping (i.e. found an item. wants to terminate the experience, etc.). If so, the method 100B proceeds to step 110B; otherwise, the shopping ends at step 114B.

In one embodiment, the manikin is created based on the information from the shopper. For example, the virtual shopping method determines the physical characteristics of the shopper and reflects the characteristics, such as, weight, height, physical build, face shape, eye color, hair color, etc., on the manikin. Accordingly, the manikin may resemble the shopper and may allow for trying out the products presented in the shopping environment, such as, trying on clothes, hats, makeup, glasses, etc.

In another embodiment, the shopping environment is in a format of shopping stores. In such an environment, the manikin may shop from store to store, as a person would in a real-world shopping experience.

In yet another embodiment, the personal shopper utilized this information to customize the shopping experience, environment or products presented to the user in the 3D/virtual shopping environment. The shopper and the personal shopper may undergo a shopping experience together. If the items are found the shopping experience is finalized by checking out, arranging for payment, arranging for shipping etc.

In another embodiment, the user information may be archived, entered or electronically determined via scanners, photos, etc. As such, the shopping expert offers shopping, options, such as, products, environment, etc., options determined and altered based on the received or learned shopper information.

FIG. 2 depicts an embodiment of a Shopping System 200. The shopping system 200 creates a shopping environment that is supported by a personal shopper. The shopping system 200 includes a memory or storage medium 202, processor 204, and a shopping module 206. The processor 204 is capable of accessing data in memory 202. The shopping module 206 may generate data that is archived in memory 202. The shopping module 206 is better described in FIG. 3. The shopping system 200 is capable of interacting with various input output devices, peripherals and systems, which are referred to herein as I/O 208, such as, a display, monitor, computer system, LCD, printers, portable devices, projections, etc.

FIG. 3 depicts an embodiment of a shopping module 206 of FIG. 2. The shopping module 206 includes a 3D/virtual shopping environment module 203, a 3D/virtual personal shopper module 304 and a shopping execution module 306. The 3D/virtual shopping environment module 302 creates a shopping environment that allows a shopper to experience a real-world shopping experience in a 3D/virtual reality environment, which may utilize 3D apparatus such as glasses, head wear and the like. The shopper may be able to walk from store to store, mall to mall, or shopping experience to another. The different environments may be by product type, store type or based on the shopper's preference. The 3D/virtual personal shopper 304 helps the shopper navigate in the shopping environment—navigate products, stores, experience etc. The shopping execution module 306 helps the shopper through a sales transaction, which may be executed in the same environment or a different environment. The 3D/virtual personal shopper 304 may include a checkout process, payment navigation tools, shipping navigation tools and the like. The shopper may be able to customize the shopping experience or environment based on size, quality, subject of interest, location type and the like.

It will be appreciated by those skilled in the art that changes could be made to the embodiments described above without departing from the broad inventive concept. It is understood, therefore, that this disclosure is not limited to the particular embodiments herein, but it is intended to cover modifications within the spirit and scope of the present disclosure as defined by the appended claims.

What is claimed is:

1. A virtual shopping method for mimicing a real-world shopping experience, comprising:
retrieving information of at least one shopper;
creating a shopping environment based on the information;
directing the at least one shopper through the shopping environment, wherein the shopping environment mimics a real-world shopping experience; and
finalizing the shopping experience, wherein the finalizing is at least one of checking out and terminating the shopping.

2. The virtual shopping method of claim 1, further comprising at least one of:
creating a manikin based on the information;
determining the physical characteristics of the shopper and reflecting the characteristics on the manikin, wherein the manikin resembles the shopper; and
trying out the products of the shopping environment utilizing the manikin.

3. The virtual shopping method of claim 1, wherein the shopping environment comprises shopping stores and wherein the shopper utilizes the manikin to shop from store to store as in a real-world shopping experience.

4. The virtual shopping method of claim 1, wherein the shopping environment comprises an avatar personal shopper presents at least one of items and a shopping environment based of the information of the shopper, wherein the avatar personal shopper navigates at least one of the at least one shopper, shopping products, shopping stores, shopping experience and the shopping environment.

5. The virtual shopping method of claim 1, wherein at least one of the shopping environment, manikin, and an avatar personal shopper are altered based on at least information change and newly learned information.

6. The virtual shopping method of claim 1, wherein the finalizing step comprises at least one of checking-out, payment, layaway, accessing a payment website, and a shopping cart.

7. A virtual shopping apparatus utilized to mimic a real-world shopping experience, comprising:
a storage medium for archiving shopper data;
a processor, coupled to the storage medium, for retrieving information of at least one shopper;
a shopping module, communicating with the processor, for creating a shopping environment based on the information and for directing at least one shopper through the shopping environment, wherein the shopping environment mimics a real-world shopping experience, wherein the shopping module is capable of finalizing the shopping experience.

8. The virtual shopping apparatus of claim 7, wherein the shopping module presents the at least one shopper with a manikin with physical characteristics of the shopper and reflecting the characteristics on the manikin, wherein the manikin resembles the shopper to allow the at least one shopper to try out the products of the shopping environment utilizing the manikin.

9. The virtual shopping apparatus of claim 7, wherein the shopping environment comprises shopping stores and wherein the shopper utilizes the manikin to shop from store to store as in a real-world shopping experience.

10. The virtual shopping apparatus of claim 7, wherein the shopping environment comprises an avatar personal shopper presents at least one of items and a shopping environment based of the information of the shopper, wherein the avatar personal shopper navigates at least one of the at least one shopper, shopping products, shopping stores, shopping experience and the shopping environment.

11. The virtual shopping apparatus of claim 7, wherein at least one of the shopping environment, manikin, and an avatar personal shopper are altered based on at least information change and newly learned information.

12. The virtual shopping method of claim 7, wherein the finalizing step comprises at least one of checking-out, payment, layaway, accessing a payment website, and a shopping cart.

13. The virtual shopping method of claim 7, wherein the shopping module comprises at least one of a 3D virtual shopping module, a personal shopper module and a shopping execution module.

14. A virtual shopping system utilized to mimic a real-world shopping experience, comprising:
a 3D apparatus for viewing a 3D environment;
a 3D apparatus, comprising:
a storage medium for archiving shopper data;
a processor, coupled to the storage medium, for retrieving information of at least one shopper;
a shopping module, communicating with the processor, for creating a shopping environment based on the information and for directing at least one shopper through the shopping environment, wherein the shopping environment mimics a real-world shopping experience, wherein the shopping module is capable of finalizing the shopping experience.
